(19) United States
(12) Patent Application Publication
(10) Pub. No.: US 2005/0078195 A1
(43) Pub. Date: Apr. 14, 2005

(54) Mobile digital surveillance system

(76) Inventor: Craig K. VanWagner, Chino, CA (US)

Correspondence Address: CHRISTIE, PARKER & HALE, LLP, PO BOX 7068, PASADENA, CA, 91109-7068, US

(21) Appl. No.: 10/964,131

(22) Filed: Oct. 13, 2004

Related U.S. Application Data
(60) Provisional application No. 60/510,875, filed on Oct. 14, 2003.

(51) Int. Cl. H04N 7/173; H04N 5/76; H04N 7/16; H04Q 7/20; H04B 1/38; H04H 1/00; H04M 1/00; H04M 11/00

(52) U.S. Cl. 348/231.3; 725/62; 348/231.7; 348/231.9; 455/403; 455/3.01; 455/414.1; 455/566

(57) ABSTRACT

A mobile recording device includes a flexible camera head for capturing video stream data in real time; a microphone for capturing audio data in real time; a position determining module for capturing position data for the mobile recording device; a first and a second replaceable memory modules for storing the video stream data and the audio data, wherein the first replaceable memory module can be replaced when the second replaceable memory module is being used to store the video and audio data and the second replaceable memory module can be replaced when the first replaceable memory module is being used to store the video and audio data. The mobile recording device may further include a wireless transceiver for wirelessly transmitting the video, the audio, and the position data to a remote location and receiving data from the remote location.

### CROSS-REFERENCE TO RELATED APPLICATION(S)

This patent application claims the benefit of the filing date of U.S. Provisional Patent Application Ser. No. 60/510,875, filed Oct. 14, 2003, and entitled “MOBILE DIGITAL SURVEILLANCE SYSTEM”, the entire contents of which are hereby expressly incorporated by reference.

### FIELD OF THE INVENTION

The present invention relates generally to wireless video/audio devices; and more particularly to a personal mobile digital recording system.

### BACKGROUND OF THE INVENTION

Some of the top complaints from those who use videotape systems are related to reliability, quality, and size. These systems, based on consumer technology, simply aren't designed to operate on a daily basis in rigorous environments. They break often and become a burden, especially to larger departments whose operating requirements tend to worsen as they grow larger. As for quality, consumer based videotape technology has limited quality even in its optimal state. For example, size, cleaning recording heads, replacing tapes with new tapes, SP mode, and cool operating temperatures limit the quality and convenience of using consumer based videotape technology for surveillance purposes. Quality further degrades when any of these variables changes over time.

Even when an image is recorded under optimal conditions, the quality of the video will degrade over time, for instance, every time the video is reviewed, or when the tape itself is subjected to extreme temperatures. These deficiencies can loom large when, for example, a jury must decide guilt or innocence from seemingly minor details on a videotape. There currently exists a void in the market for a small solid-state video recorder that can be useful for surveillance purposes. Therefore, there is a need for a mobile digital surveillance system with enhanced video recording and video management.

### SUMMARY OF THE INVENTION

The present invention provides an improved method and system for a personal mobile digital recording system (MDRS) to capture activities of, for example, a law enforcement officer.

In one embodiment, the present invention is a mobile recording device including a flexible camera head for capturing video stream data in real time; a microphone for capturing audio data in real time; a position determining module for capturing position data for the mobile recording device; a first and a second replaceable memory modules for storing the video stream data and the audio data, wherein the first replaceable memory module can be replaced when the second replaceable memory module is being used to store the video and audio data and the second replaceable memory module can be replaced when the first replaceable memory module is being used to store the video and audio data.

In one embodiment, the mobile recording device further includes a wireless transceiver for wirelessly transmitting the video, the audio, and the position data to a remote location and receiving data from the remote location. For example, the mobile recording device is capable of receiving a command from the remote location to start recording data, and/or to transmit its location data.

The mobile recording device may include a compass for indicating a direction the camera head is pointing to, a finger print sensor for capturing and transmitting finger print data in real time, and/or a facial scanning module for capturing and transmitting facial profiles in real time.

In one embodiment, the present invention is a mobile recording device including: a flexible camera head for capturing video stream data in real time; a microphone for capturing audio data in real time; a circular buffer for continuously storing the video stream data and the audio data; and a wireless transceiver for transmitting the video and audio data in real time to a remote location.

In one embodiment, the present invention is a mobile recording device including: a flexible camera head for capturing video stream data in real time; a microphone for capturing audio data in real time; a finger print sensor for capturing finger print data in real time; and a wireless transceiver for transmitting the video, audio, and finger print data in real time to a remote location and for receiving commands from the remote location.

These and other-features of the present invention will become readily apparent in view of the accompanying drawings and the detailed description of the embodiments.

### BRIEF DESCRIPTION OF THE DRAWINGS

FIGS. 1A and 1B are exemplary diagrams illustrating an exemplary embodiment of the present invention;

FIG. 2 is an exemplary system block diagram, according to one embodiment of the present invention;

FIG. 3 is an exemplary system block diagram, according to one embodiment of the present invention depicting a wireless capability; and

FIG. 4A illustrates an exemplary wireless adaptor for a mobile digital recording system, according to one embodiment of the present invention;

FIG. 4B shows a mobile digital recording system next to a wireless adaptor and the general alignment of the two units, according to one embodiment of the present invention; and

FIG. 4C is an exemplary charging base for a mobile digital recording system, according to one embodiment of the present invention.

### DETAILED DESCRIPTION

In one embodiment, the present invention is a personal mobile digital recording system (MDRS) to capture activities of, for example, a law enforcement officer for his entire shift. The MDRS of the present invention is truly mobile as it is smaller than most cell phones and can travel with users wherever they go. The MDRS captures audio/video feeds from user's pocket and provides date, time and GPS location data for an extended period of time.

In one embodiment, the present invention is a MDRS that can be placed in a vehicle one moment, or be mobile with its operator in the next. The MDRS knows the location of its operator, the direction that the camera is pointing, and can transmit that location and direction back to a remote operations center. It can also transmit live video back to the operations center. The MDRS is capable of automatically saving the entire shift of a law enforcement officer, for example, for 10-12 hours, or more. It saves compressed video files in an easy to use computer format eliminating the need for vast video tape archives. Additionally, the MDRS of the present invention may be used by accident investigators to review the last several hours of, for example, a school bus's operation. Insurance investigators may use the MDRS to identify all of the vehicles involved in a big rig truck accident, for example.

In one embodiment, the MDRS provides users with a simple and effective audio and video log of their day activities. The MDRS may be placed in a docking station on the dashboard of a vehicle, clip into a shirt pocket, or attach to the front of a tactical vest. A small LCD screen on the back of the MDRS displays what is being captured by the video recorder.

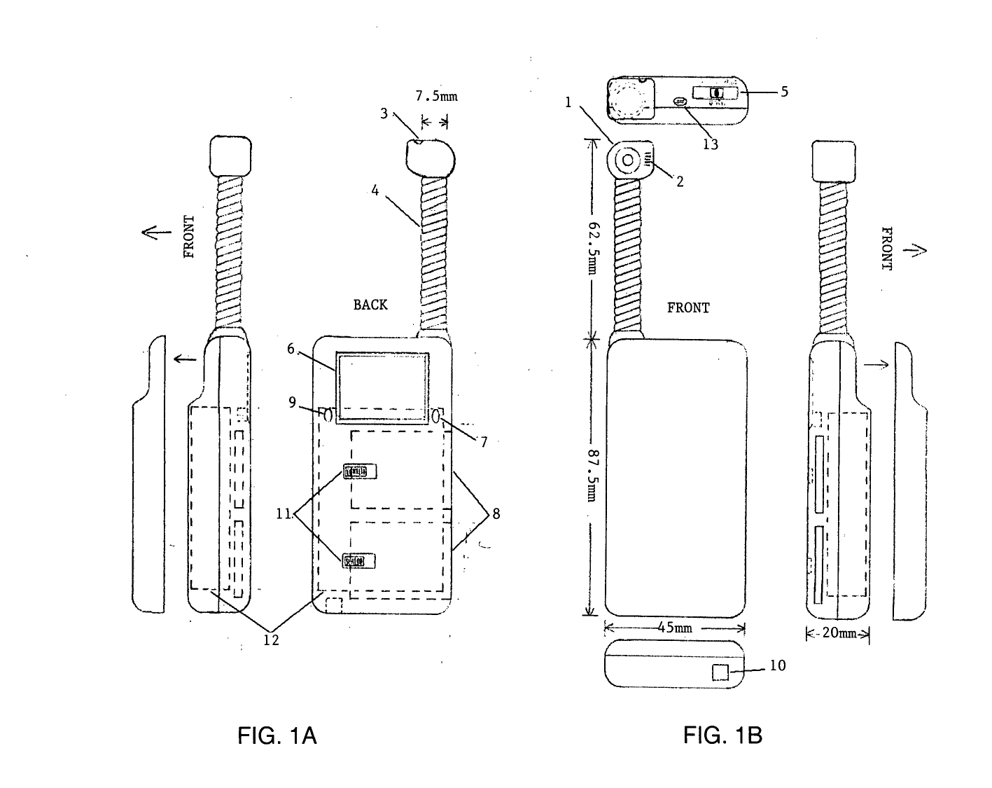

FIGS. 1A and 1B are exemplary diagrams illustrating an exemplary embodiment of the present invention. FIG. 1A depicts a back and a first side view of an exemplary MDRS, while FIG. 1B illustrates a front, a second side view, top and bottom views f the MDRS. The measurements indicated in FIGS. 1A and 1B are exemplary sizes and may vary in different embodiments of the present invention.

The MDRS depicted in FIGS. 1A and 1B may be changed and redefined to achieve a more aesthetic appearance or to achieve the technological requirements. The MDRS includes the following components: at least two removable Secure Digital (SD) memory cards (or any other replaceable memory modules) 8, a LCD screen 6, a camera head 1 with color CCD Sensor that supports replaceable lenses, a microphone 2, a flexible support 4 for the camera head, a Li-ion battery 12, one or more video outputs (not shown), and optionally a small speaker (not shown).

The MDRS also includes cellular support for video and audio transmission, and MPEG (e.g., MPEG4 and/or MPEG2) video and audio capability. The video and audio data are recorded in the alternating SD memory cards.

The MDRS also includes an On/Off status LED 3, and On/Hold/Off switch 5, a LCD On/Off button 7, a memory/data storage change button 9, a power connector 10, a memory/data storage eject 11, a battery case open latch 13, a button for establishing cellular data connection with preprogrammed number to transmit video and audio (not shown), a button for disconnecting cellular data connection (not shown), a cellular antenna (not shown), and a battery cover (not shown).

The camera head supports color CCD and/or CMOS sensors. Camera head also supports user replaceable lens choices of a variety of sizes.

In one embodiment, the MDRS records in an endless loop using two or four replaceable memory modules. The amount of data recorded is dependent on the capacity of the SD cards. For instance, using the high capacity SD cards enables the unit to capture in excess of 24 hours of video and audio data. SD cards may be “hot” ejected and swapped to secure any video and audio data previously recorded. The MDRS incorporates a GPS (Global Positioning System) chip and antenna. GPS location information is encoded as part of the video and audio data stream. Other position determining modules are also available and may be used in some embodiments of the present invention.

The MDRS incorporates a wireless data transceiver. This enables the user to manually initiate a live video feed to a remote control center. Additionally, the control center may remotely instruct the unit to initiate a live data and/or video feed.

In one embodiment, video is captured in color at a resolution of 360×240 at 30 frames per second. The encoding format is MPEG4 and can achieve upwards of 40:1 compression. The video capture device (camera head 1) is located on the top of a flexible stalk or gooseneck in an enclosed camera head.

Flexible stalk 4 contains the video camera head as well as microphone 2. The camera stalk can flex to allow the video camera to be positioned to best capture the scene. The camera stalk attaches to the MDRS body via a plug and is secured by a mounting cap (not shown). Multiple camera stalks and wired accessories may be used to address different field requirements.

The stalk is stiff enough so that the camera head won't inadvertently move. The camera head can be aimed by rotating it at the end of the stalk, and/or by bending the stalk in the desired direction. The stalk plugs into the MDRS body and is secured by a mounting cap. Some embodiments may not include the stalk. These wired camera heads can be used for remote mounting of the camera head. Wired lengths vary depending on the application. These wired lengths include the video capture device and a microphone enclosed in the camera head, a wire run, a MDRS body plug, and one or more securing mounting cap(s).

In one embodiment, the MDRS uses a new generation integrated charge couple device (CCD), or CMOS imaging technology, for example, a Sanyom CCD containing anti-blooming, auto-white balance and auto-exposure capabilities. The CCD is preferably low-light capable. Different lenses may be mounted on the camera head. The user choice of the lens determines the field of view captured. Lenses ranging, for example, from 4 mm to 16 mm are currently available and may be changed by the user.

In one embodiment, the MDRS includes single chip micro-fluxgate compass CMOS technology for “Situational awareness.” Compass bearing data will be encoded as part of an “overlay” channel in the MPEG data stream. For example, a Microsystems Design Groups Integrated micro fluxgate sensor may be used.

In one embodiment, the MDRS uses a micro-fluxgate sensor integrated onto a CMOS IC process. The micro-fluxgate sensor is low noise and low temperature with a sensor response sensitivity. Exemplary micro-fluxgate sensors are described in P. M. Drljaca, P. Kejik, F. Vincent, R. S. Popovic, “Low Noise CMOS Micro-Fluxgate Magnetometer”, Transducers'03, Boston, Mass., USA, pp. 304-307, Jun. 8-12-4, 2003; and P. M. Drljaca, P. Kejik, F. Vincent, D. Piguet, F. Gueissaz, R. S. Popovic, “Single Core Fully Integrated CMOS Micro-fluxgate magnetometer”, EUROSENOSRS XV September 15-18, Prague, Czech Republic; the entire contents of which are fully incorporated herein by reference.

In one embodiment, audio is recorded in monaural at 16 k bits/second approximately the quality of AM radio. The microphone incorporated into the camera head is sensitive enough to pick up a quiet conversion for example, from more than 5 meters.

In one embodiment, video, audio, date and time, GPS overlay channel, electronic compass bearing channel, and biometric data overlay channel are encoded in an MPEG data stream. Any attempt to alter the data stream would affect the date and time encoding in the data stream. The MPEG data stream is written and saved on replaceable memory modules. Current measurements indicate that an MPEG data stream containing video+audio+date and time+40 bytes GPS and Compass+120 bytes bio encodes at a rate of 512 bps. The GPS and bio overlay data are preferably encoded in P-Frame data packets and not in every data packet.

In one embodiment, the MDRS records in two replaceable memory modules alternating between them automatically in an endless loop. Operator's may eject one replaceable memory module and replace it while the MDRS is still recording to the other replaceable memory modules. The replaceable memory modules may be write protected using the “Write Protect” tab on the replaceable memory modules. The MPEG data format is tamper proof eliminating chain of evidence questions. This is because video frames are time stamped frequently.

In one embodiment, the MDRS includes GPS capability. GPS location data is encoded in the MPEG data stream to track the location of the MDRS. The location may be periodically recorded. The period of the location recordation is programmable by the user. The location data combined with the date and time data give an accurate history of the location of the MDRS.

In one embodiment, the MDRS includes an electronic compass. Compass bearing data indicates the direction the camera is pointing. This compass bearing data combined with GPS data and the date and time data provide a new level of situational awareness for monitoring facilities or site/area surveys. Compass bearing information is encoded as part of the video and audio data stream. The compass information may also be displayed on the LCD.

Additional biographical data or text may also be encoded as part of the data stream. This additional data may include the MDRS unit ID, date and time, or any other personnel data stored in the MDRS firmware.

The MDRS is capable of transmitting live data to a control monitoring system. The monitoring system can plot the location of the MDRS, or provide the location data to another system. The monitoring system can display the real-time video and audio provided by multiple MDRS units. In addition, biographical data may be overlaid on the video image to identify the MDRS's operator. In one embodiment, simple text overlay may be inserted by the operator over video frames. Text may be entered by a plug-in keyboard or by pre-programmed buttons on the MDRS. Live transmission may be initiated by the MDRS's operator, or may be remotely initiated by the control monitoring system.

In one embodiment, operational controls for the MDRS are basic and simple. When the system is turned on, it starts recording until it is turned off. The operator may turn the LCD screen on and off, and may instruct the MDRS to change recording to the “other” SD card. The operator may eject and replace the SD cards. The operator may initiate or terminate a live transmission.

In one embodiment, MDRS setup controls are menu driven and much more extensive. Some of the controls include:
setup of the operator's biographical data.
enabling or disabling of audio.
live transmission connection parameters.
date and time formats.
automatically start recording on power up.

In one embodiment, MDRS automatically recharges when placed in its docking station. Clips and vest attachments allow the MDRS to be carried in a shirt pocket or attached to a tactical vest. Docking stations can be mounted on a vehicle dashboard and the MDRS placed into it when the operator returns to the vehicle. This provides for a vehicle based camera while the operator is in the vehicle and a personnel based camera while the operator is away from the vehicle.

The docking station includes a stable platform for the camera to sit in. The camera platform provides stability in all directions. Preferably, the camera should not be able to be “bounced” out of docking station. The LCD, LCD On/Off button and memory/data storage change button are visible and accessible while camera is docked. Camera is charged while sitting in the docking station. Docking Station will accept AC or DC power and delivers DC power to the camera.

In one embodiment, the MDRS may be permanently mounted and with the use of the wired camera head, and a longer wire run length, the camera head may be positioned in a more advantageous way. The MDRS can be configured to automatically start recording when power is applied, and to stop recording when power is turned off. An example for this use would be a permanent mounting in a vehicle like a bus. In one embodiment, the start and stop functions are voice activated using a voice recognition module.

In one embodiment, the docking station is powered and provides a charging port for the unit. A high energy Li-Ion battery powers the MDRS for at least ten hours at a time. By periodic placement into its docking station, the MDRS may be left on indefinitely. The MDRS may be wired directly to a power source for permanent mounting options. Those skilled in art would easily recognize that other forms of providing power to the MDRS and the docking station, such as different battery technologies, or different types of power sources, are possible.

Other features in some embodiments include:
PCcard card interface supporting multiple wireless solutions and international standards,
finger print sensor to capture and transmit finger prints in real-time,
facial scanning/identity software to capture and transmit facial profiles in real-time, and
support for integrated facility control room monitoring software.

In one embodiment, microphone 2 is integrated into the camera head 1. Microphone 2 is sensitive enough to pick up a quiet conversion at approximately 5 meters or more.

In one embodiment, the camera head 1 includes a micro LED. The status LED 3 faces toward the back and top of the camera so that it is not visible from in front of the Camera, as shown in FIG. 1A. The LED displays the following colors on the following conditions:
Green—Camera is recording
Green Flashing—Camera is transmitting
Red—Camera is recording, but power level is low

In one embodiment, the camera head support supports up to 95° (from vertical) change in camera angle in any direction. Camera head support is typically “stiff” enough to prevent unintended change in angle. Camera head can swivel about 450 (from horizontal).

The camera starts recording when the On/Hold/Off switch 5 is placed into the “On” position. When recording, all other buttons on the Camera will remain functional. When the switch is placed into the “Hold” position, all other buttons on the camera are disabled. Placing the switch into the “Off” position turns the camera off.

The color LCD 6 (or other small display technologies) displays the CCD image. When the camera is powered “On”, the LCD is enabled. In one embodiment, the LCD displays the following information, date and time, battery power level, A/B (A/B/C/D) memory card active, A/B time (HH:MI:SS) of saved data, cellular transmission active, and/or any other needed information.

“Date and Time” are user selectable: “Battery Power Level” indicates how much recording time is remaining. If the battery 12 is being charged, the recording time indicator will flash. “A/B/C/D memory card active” indicates which SD Memory, card is currently being written to. “A/B HH:MI:SS of saved data indicates the hours, minutes and seconds of recorded data in each SD memory card. The above status are typically for user's information only and are not recorded on video image. However, in one embodiment, selective data may be recorded on the video image or audio data. The LCD On/Off button 7 toggles the LCD on or off. This button only disables the LCD, while the camera is still recording.

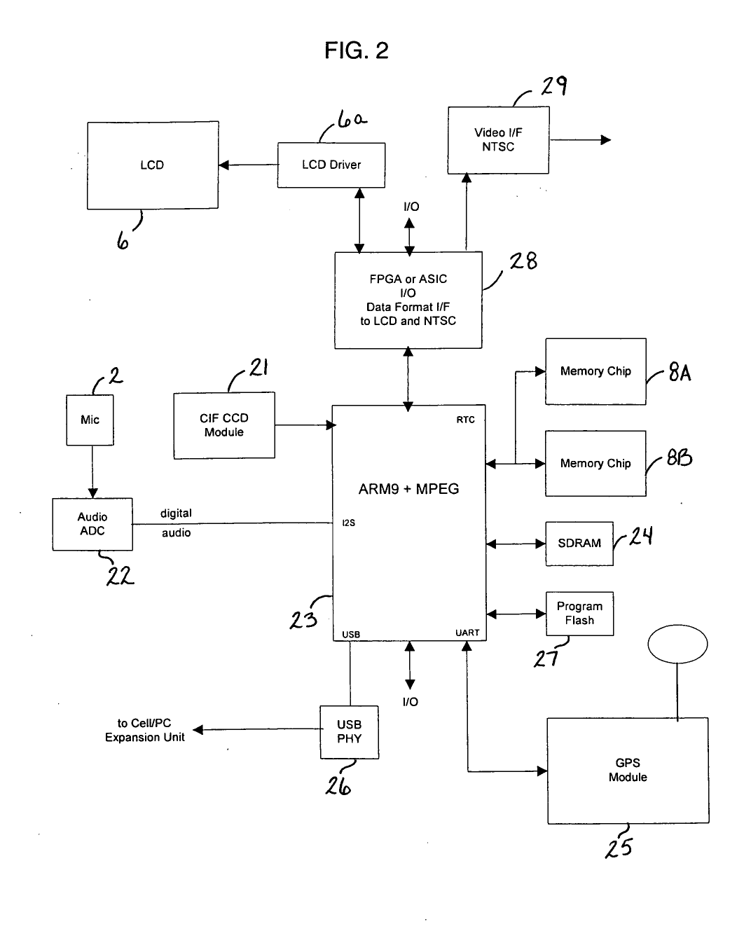

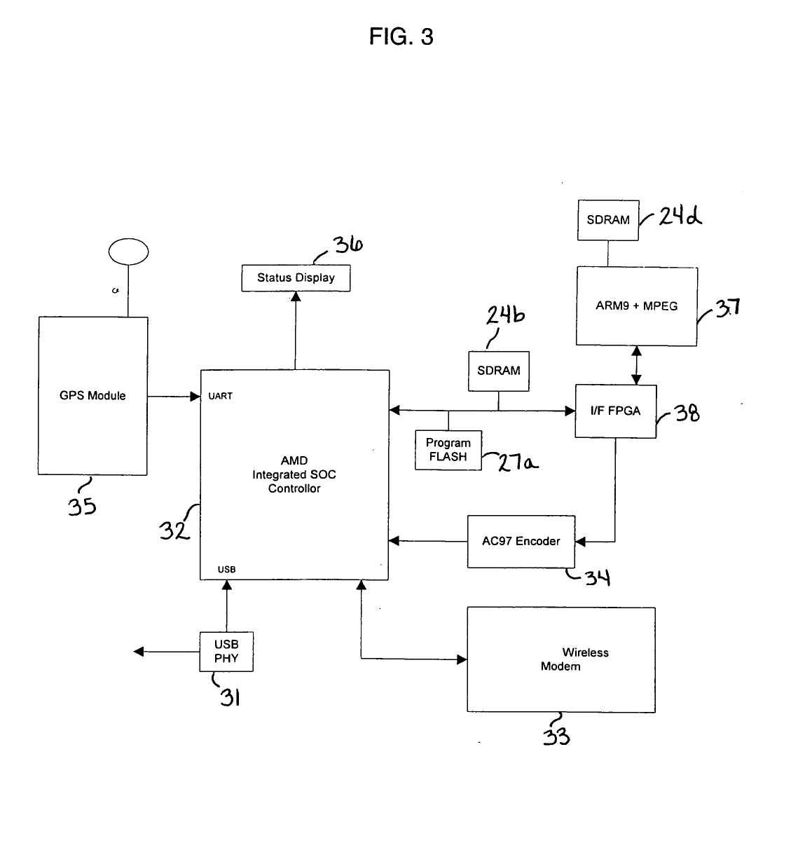

FIG. 2 is an exemplary system block diagram, according to one embodiment of the present invention, without a wireless capability. FIG. 3 is an exemplary system block diagram, according to one embodiment of the present invention depicting a wireless capability, either as a separate module connectable to the main module of FIG. 2, or integrated with the main module of FIG. 2. The wireless capability may be packaged as a expansion module pluggable into the main unit. The wireless capability may be used to transmit video, audio, and/or position data to a remote location and receive data, such as commands from the remote location. For example, the remote location may send a command to the MDRS to start recording and/or to transmit its location data, using a specific identification number for the specific MDRS,

As shown in FIG. 2, images are captured through an integrated lens via the CIF CCD Module 21. This module coverts light to electronic signals using a CCD. The analog electrical signals from the CCD are digitized by an A to D converter (ADC) located in this component. The output of this module includes pixels of image data at 24 bits/pixel. (8 bits Red, 8 bits Green and 8 bits Blue.) This video stream is made up of a group of “pictures” or frames which are taken at up to 30 times per second. Audio is captured by microphone 2 and digitized by the Audio ADC 22.

The output data of the CCD module and the Audio ADC is fed into an encoding device 23. The encoding device 23 stores each video frame in a SDRAM 25, and compresses the stream of frames using, for example, the MPEG4 and/or MPEG2 standards. Compressed audio is also multiplexed into the stream at this point. The encoding device does this via software algorithms executed by an internal processor (for example, ARM9 included with the encoding device 23) and/or hardware acceleration blocks. In addition, the processor reads a GPS device 25 and a real time clock (not shown) and embeds this information in the MPEG stream. The resulting MPEG compressed audio/video stream is stored in the SDRAM 24 as well. The processor is also capable of reading an I/O port (not shown) for received data from a remote location. An LCD driver 6a provides the video data to be displayed by the LCD 6.

The FPGA or ASIC chip 28 manages sensor control, the image path, address generation, the memory chip interface, and also includes other glue logic. This chip's functionality can be upgraded from program FLASH 27. Real-time video output is available from the Video I/F module 29.

The MPEG compressed audio/video stream is then copied to the replaceable memory modules 8A and 8B, via a direct memory access (DMA) process. In addition, the compressed audio/video stream can be sent out of the unit through an output interface, for example, a USB interface 26, again using a DMA process.

In one embodiment, the cellular capability is provided via an expansion module pluggable to the main unit. In this embodiment, the MPEG stream is received from the main unit via a USB interface 31 (or other interface) by the expansion module, as shown in FIG. 3. In this case, a MPEG device 37, such as, Sanyom MPEG device is used for decoding and returning the video to an integrated SOC controller 32, and an audio stream encoded by an audio codec 34 to create a lower quality audio/video stream (e.g., sub-sampling) for transmission over the cellular network through a wireless transceiver 33. For example, a PCMCIA compatible wireless modem may be used to transmit the data. However, other wireless transceivers may be plugged into or be an integral part of the MDRS for transmitting and receiving data.

The MPEG device 37 and the SOC controller 32 interface through the FPGA 38. Programming is stored in program FLASH 27a and can be upgraded as new features become available. Each processor 32 and 37 have their own processing memory areas 24b and 24d respectively. A text based I/O port is available for status display 36.

Since the bandwidth of the cellular modem is much lower than the bandwidth which can be stored in the replaceable memory modules 8A and 8B, this re-compression step is needed. The quality of the audio/video stored in the main unit is of much higher quality than the stream sent via the cellular network.

Thus, the MDRS of the present invention is capable of simultaneous storing of video on replaceable memory modules and outputting data in real-time for wireless transmission. The MDRS also embeds GPS data in an MPEG stream and converts, in real-time, MPEG format to low bit rate MPEG for wireless transmission.

In one embodiment, a wireless accessory unit, as a standalone wireless tracking unit, is capable of sending a location data stream via a cellular network to a remote location.

In one embodiment, the MDRS is capable of outputting a composite video signal. In one embodiment, the MDRS provides the user with the ability to configure or set the following data: date and time, date format, and audio on/off.

In one embodiment, MPEG4 format is used to facilitate integration of additional features into the MDRS. In this embodiment, the MDRS data includes: audio, video at 15 fps at a minimum of 320×240 pixels, encoded date and time, GPS data encoded on an “overlay” channel in the MPEG4 data stream, compass bearing data encoded on an “overlay” channel in the MPEG4 data stream, and MDRS unit identifier and any user profile information encoded onto an additional “overlay” channel in the MPEG4 data stream.

This gives the MPEG4 Player (playback is preferably PC based) the ability to show these additional graphics as “overlays” onto the video data. Because they are a separate part of the encoded data stream, they do not affect the video quality.

MPEG format allows the data files to be played back on a Windows™ computer. The MDRS is capable of sending the video/audio and other data to a PC via the USB interface 26 and/or via a wireless communication link. MPEG players for Windows™ computers are commercially available. These MPEG players may be used for testing the camera data by ejecting the replaceable memory module and connecting it to a Windows-computer using a memory card reader. The MDRS data file are able to be viewed using several different MPEG players.

In one embodiment, the GPS information is encoded as part of an “overlay” channel in the MPEG-4 data stream. For example, a Motorola™ chip (Same as item 25 in FIG. 2), which is a self-contained, single-chip assisted global positioning system (A-GPS) receiver may be used.

In one embodiment, the MDRS is capable of sending live video and audio back to an operations support system. Antenna placement is typically on top, on the opposite side of the camera stalk. MDRS firmware contains preprogrammed callout numbers. Under normal operations, the MDRS may be called by a remote site to initiate transmission of data. In one embodiment, Sandbridge™ SB9600 chipset is used for data transmission. The chip set supports multiple cellular markets by varying the communication protocols on a Software-Defined-Baseband processor chip. This might be accomplished by loading the “A” replaceable memory module with CDMA, GPRS, GSM or 802.11g, and the like programming.

In one embodiment, the MDRS records video and audio in MPEG4 format. This format allows date/time encoding in the data stream. The MDRS provides this Date/Time data to the MPEG4 encoder. When the MDRS is powered “On” the user confirms that all image files will be erased. Once the user has confirmed that all image files can be erased, the MDRS starts recording and creates a new image file in the “A” (top) replaceable memory module. All previous image files on the “A” replaceable memory module are removed and therefore, the entire replaceable memory module is available for recording. When the “A” replaceable memory module is full, the MDRS creates a new image file in the “B” replaceable memory module.

All previous image files on the “B” replaceable memory module are removed and no confirmation of file erasure is required. The entire replaceable memory module is available for recording. When the “B” replaceable memory module is full the MDRS starts recording again on the “A” replaceable memory module and no confirmation of image file erasure is required. The process of switching back and forth between the replaceable memory modules is automatic and is maintained for as long as the camera is “On”. More than two replaceable memory module, such as four replaceable memory module, may be used. The “non-active” replaceable memory module may be ejected and replaced at anytime without interrupting the current recording. This provides the MDRS with even a higher storage capacity.

If the MDRS contains only a single replaceable memory module, the MDRS automatically records in the single replaceable memory module. In one embodiment, the MDRS divides the available memory into two image files of equal sections. These sections will represent the “A” and “B” sections as described above. The MDRS alternates between the two image files on the single replaceable memory module. In one embodiment, the single replaceable memory module includes a single image file configured as a circular buffer. The single replaceable memory module is then operated as a circular buffer, in which the video, audio, and other data is being continuously recorded in the single replaceable memory module in a circular manner.

In one embodiment, the image files created on the SD memory card are named according to the following format: YYMMDDHHMI.mp4 (YY=Year, MM=Month, DD=Day, HH=Hour, MI=Minute). The “A” SD memory card may contain a configuration file containing firmware settings required for cellular connection parameters, video server address and port number, operator information, etc. The firmware should save the last configuration data for use, if no configuration file is present.

Preferably, there should not be a gap in video and audio recording while the camera is switching between the replaceable memory modules, or files. Preferably, video history equal to or greater than half of the recording time available to a replaceable memory module capacity is maintained. A memory/data storage change button directs the camera to change recording to the “other” replaceable memory module. This allows the user to eject, replace and save the SD memory card containing video and audio history.

In one embodiment, a power connector provides DC auxiliary power source for camera operation. When the camera is plugged in to an auxiliary power source the camera operates as normal and recharge the Li-ion battery. The LCD should indicate that the battery is currently being charged.

A memory/data storage eject sliding latches allow the SD memory cards to be ejected. A battery case open latch keeps the battery cover closed and locked. To remove the battery case, the battery case open latch is pressed and the top of the battery case is rotated away from the camera body.

A wireless data connection button manually establishes a data connection to transmit video and audio to pre-programmed service (for example Verizon™ 1×RTT Express Network). The MDRS sends a secondary MPEG data stream to designated server. An end wireless data connection button ends the wireless transmission. In one embodiment, an embedded non-telescoping antenna is used for wireless transmission/reception of data.

In one embodiment, finger print sensor technology is overlaid on top of the display screen to provide a mechanism for fingerprints to be captured and transmitted in real-time to a remote facility for evaluation. In one embodiment, the MDRS includes facial scanning/identity software to provide real-time crowd scanning and facial profile transmission back to a remote facility for identity processing.

In one embodiment, in addition to one or more USB interface, the MDRS includes PCcard interface to use existing wireless PCcard technologies in the USA and internationally. These cards currently support Cellular data, IEEE 802.11 Communication Standards, Bluetooth, etc. An Internet interface for connecting to, browsing, and downloading data from the Internet may also be provided with the MDRS.

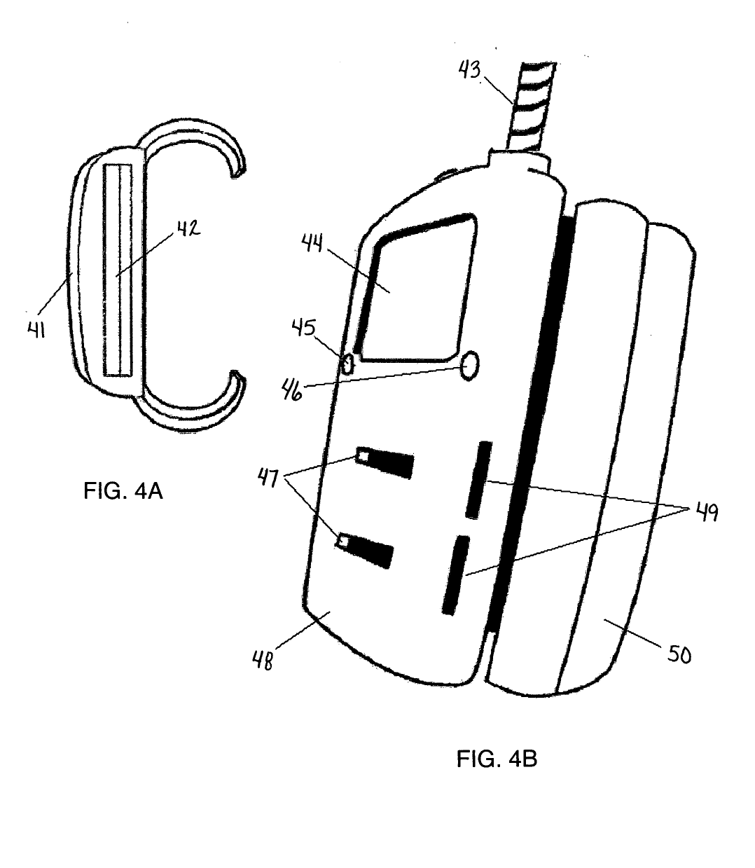

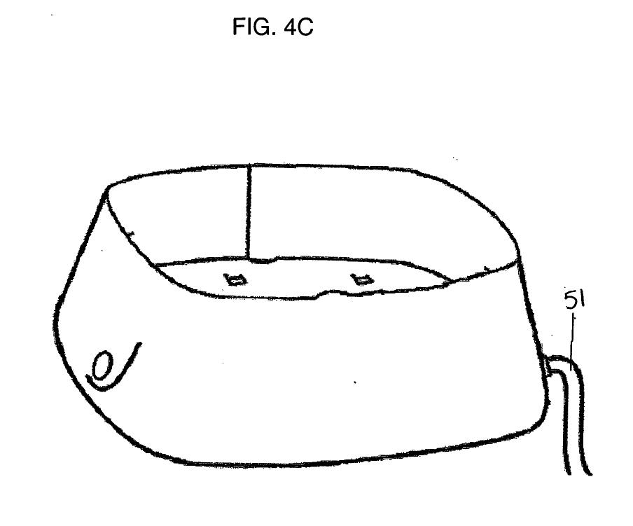

FIG. 4A illustrates an exemplary wireless adaptor for a mobile digital recording system, according to one embodiment of the present invention. The adaptor fits onto the main MDRS like a sleeve, by sliding the main MDRS unit into the adaptor from the top down. This wireless adaptor contains a battery 41, and a slot 42, into which a wireless card is fitted. The wireless adaptor provides the MDRS unit with an integrated solution for broadcasting live audio and video from a remote location. The wireless card slot utilizes existing wireless technologies, like PCcard cellular modems and 802.11 cards, to transmit video and audio as a data stream to a remote monitoring facility.

FIG. 4B shows a mobile digital recording system next to a wireless adaptor and the general alignment of the two units, according to one embodiment of the present invention. In this embodiment, the MDRS includes a flexible support 43 for the camera head (not shown), an LCD screen 44, a memory/data storage change button 45, an LCD On/Off button 46, a memory/data storage eject 47, a MDRS unit body 48, removable memory card slots 49, and a wireless adaptor body 50.

FIG. 4C is an exemplary charging base for a mobile digital recording system, according to one embodiment of the present invention. This Charging base supplies continuous power to an MDRS unit for operations and recharging. This Charging base is designed for easy mounting. Power is provided through a power cable 51.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims.

1. A mobile recording device comprising:
a flexible camera head for capturing video stream data in real time;
a microphone for capturing audio data in real time;
a position determining module for capturing position data for the mobile recording device; and
a first and a second replaceable memory modules for storing the video stream data and the audio data, wherein the first replaceable memory module can be replaced when the second replaceable memory module is being used to store the video and audio data and the second replaceable memory module can be replaced when the first replaceable memory module is being used to store the video and audio data.

2. The mobile recording device of claim 1 further comprising a wireless transceiver for wirelessly transmitting the video, the audio, and the position data to a remote location and receiving data from the remote location.

3. The mobile recording device of claim 2 wherein the wireless transceiver receives a command from the remote location to start transmitting data.

4. The mobile recording device of claim 1 further comprising a compass for indicating a direction the camera head is pointing to.

5. The mobile recording device of claim 1 wherein the flexible camera head is configured to swivel.

6. The mobile recording device of claim 1 wherein the flexible camera head is configured to include user replaceable lenses.

7. The mobile recording device of claim 1 further comprising a LCD for displaying data.

8. The mobile recording device of claim 1 further comprising input keys for entering text data to be overlayed on the video stream data.

9. The mobile recording device of claim 1 further comprising a button for establishing wireless connection with a pre-programmed remote location for transmitting the video, audio and location data.

10. The mobile recording device of claim 1 further comprising a finger print sensor for capturing and transmitting finger print data in real time.

11. The mobile recording device of claim 1 further comprising a facial scanning module for capturing and transmitting facial profiles in real time.

12. A mobile recording device comprising:
a flexible camera head for capturing video stream data in real time;
a microphone for capturing audio data in real time;
a circular buffer for continuously storing the video stream data and the audio data; and
a wireless transceiver for transmitting the video and audio data in real time to a remote location.

13. The mobile recording device of claim 12 wherein the wireless transceiver receives a command from the remote location to start transmitting data.

14. The mobile recording device of claim 12 further comprising a compass for indicating a direction the camera head is pointing to.

15. The mobile recording device of claim 12 wherein the wireless transceiver receives a command from the remote location to start recording data.

16. The mobile recording device of claim 12 further comprising a position determining module for capturing position data for the mobile recording device

17. The mobile recording device of claim 12 further comprising a finger print sensor for capturing and transmitting finger print data in real time.

18. The mobile recording device of claim 12 further comprising a facial scanning module for capturing and transmitting facial profiles in real time.

19. A mobile recording device comprising:
a flexible camera head for capturing video stream data in real time;
a microphone for capturing audio data in real time;
a finger print sensor for capturing finger print data in real time; and
a wireless transceiver for transmitting the video, audio, and finger print data in real time to a remote location and for receiving commands from the remote location.

20. The mobile recording device of claim 19 further comprising a circular buffer for continuously storing the video stream data and the audio data.
